(19) United States
(12) Patent Application Publication
(10) Pub. No.: US 2026/0296475 A1
(43) Pub. Date: Oct. 1, 2026

(54) VEHICLE CONTROL DEVICE, VEHICLE CONTROL METHOD, AND PROGRAM

(71) Applicant: HONDA MOTOR CO., LTD., Tokyo (JP)

(72) Inventors: Yuki Kitamura, Tokyo (JP); Yuki Ichino, Tokyo (JP)

(21) Appl. No.: 19/551,684

(22) Filed: Feb. 27, 2026

(30) Foreign Application Priority Data
Mar. 28, 2025 (JP) 2025-054762

(51) Int. Cl. B60W 50/14; B60K 35/29

(52) U.S. Cl. CPC B60W 50/14; B60K 35/29; B60W 2552/30

(57) ABSTRACT

A vehicle control device includes: a recognition unit configured to recognize a surrounding situation of a vehicle, and a control unit configured to determine whether the vehicle is likely to depart from a traveling lane based on a recognition result obtained by the recognition unit, and output a departure warning to a driver of the vehicle when it is determined that the vehicle is likely to depart from the traveling lane, in which the departure warning includes a first departure warning when the vehicle is traveling on a road other than a curved road and a second departure warning when the vehicle is traveling on a curved road, the control unit counts the number of activations of the first departure warning and the number of activations of the second departure warning, and changes the content of the departure warning when the number of activations is increased, and the count is treated as 1 when activation is performed consecutively from the first departure warning to the second departure warning, or when activation is performed consecutively from the second departure warning to the first departure warning.

### CROSS-REFERENCE TO RELATED APPLICATION

Priority is claimed on Japanese Patent Application No. 2025-054762, filed on Mar. 28, 2025, the contents of which are incorporated herein by reference.

### BACKGROUND

### Field of the Invention

The present invention relates to a vehicle control device, a vehicle control method, and a program.

### Background

In recent years, there have been increasing attempts to provide access to a sustainable transportation system that takes vulnerable traffic participants into consideration. In order to realize this effort, research and development into preventive safety technologies have been focused to further improve road safety and convenience. For example, in the related art, a device has been disclosed in which, a sound output unit outputs a sound indicating that at least one of departure avoidance control and warning output control is executed when n times is counted by a departure counting unit (where n is a natural number greater than 1), and at least departure avoidance control will not be executed to avoid departure from a driving path when n+1 times is counted (see, for example, claim 8 in Japanese Unexamined Patent Application, First Publication No. 2015-210680).

### SUMMARY

In the device of the related art, occupants may feel annoyed about a warning.

An object of an aspect of the present invention is to provide a vehicle control device, a vehicle control method, and a program which are capable of preventing occupants from feeling annoyed. As described above, this aspect of the present invention improves preventive safety technology, and ultimately contributes to development of sustainable transportation systems.

A vehicle control device according to a first aspect of the present invention includes: a recognition unit configured to recognize a surrounding situation of a vehicle; and a control unit configured to determine whether the vehicle is likely to depart from a traveling lane based on a recognition result obtained by the recognition unit, and output a departure warning to a driver of the vehicle when it is determined that the vehicle is likely to depart from the traveling lane, in which the departure warning includes a first departure warning when the vehicle is traveling on a road other than a curved road and a second departure warning when the vehicle is traveling on a curved road, the control unit counts the number of activations of the first departure warning and the number of activations of the second departure warning, and changes the content of the departure warning when the number of activations is increased, and the count is treated as 1 when activation is performed consecutively from the first departure warning to the second departure warning, or when activation is performed consecutively from the second departure warning to the first departure warning.

A second aspect is the vehicle control device according to the first aspect described above, in which the control unit may treat the count as 1 when activation is performed such that the departure warning becomes stronger or when activation is performed such that the departure warning is at an equal level.

A third aspect is the vehicle control device according to the first or second aspect described above, in which the control unit may count the number of activations of the first departure warning and the number of activations of the second departure warning within a first predetermined time, and may change the content of the departure warning when the number of activations is increased from 1 to 2.

A fourth aspect is the vehicle control device according to the third aspect described above, in which the control unit may count the number of activations of the first departure warning and the number of activations of the second departure warning, and may add a warning sound to the departure warning when the number of activations is increased from 1 to 2.

A fifth aspect is the vehicle control device according to the fourth aspect described above, in which the control unit may count the number of activations of the first departure warning and the number of activations of the second departure warning, and may suppress the departure warning for a second predetermined time after the departure warning is issued after the number of activations has reached two.

A sixth aspect is the vehicle control device according to the fourth aspect described above, in which the control unit may count the number of activations of the first departure warning and the number of activations of the second departure warning, and may set a time of the departure warning for a third time to be longer than a time of the departure warning for a second time.

A vehicle control device according to a seventh aspect of the present invention includes: a recognition unit configured to recognize a surrounding situation of a vehicle; and a control unit configured to determine whether the vehicle is likely to depart from a traveling lane based on a recognition result obtained by the recognition unit, and output a departure warning to a driver of the vehicle when it is determined that the vehicle is likely to depart from the traveling lane, in which the departure warning includes a first departure warning when the vehicle is traveling on a road other than a curved road and a second departure warning when the vehicle is traveling on a curved road, and the control unit does not issue a warning via a sound in the first and second departure warnings when the second departure warning is issued consecutively following the first departure warning, and issues a warning via a sound in the first or second departure warning when the first or second departure warning is issued within a predetermined time after end conditions for the first and second departure warnings are established and a control related to the first and second departure warnings is ended.

A vehicle control method according to an eighth aspect of the present invention includes causing a computer to: recognize a surrounding situation of a vehicle; determine whether the vehicle is likely to depart from a traveling lane based on a result of the recognition; and output a departure warning to a driver of the vehicle when it is determined that the vehicle is likely to depart from the traveling lane, in which the departure warning includes a first departure warning when the vehicle is traveling on a road other than a curved road and a second departure warning when the vehicle is traveling on a curved road, the number of activations of the first departure warning and the number of activations of the second departure warning are counted, and the content of the departure warning is changed when the number of activations is increased, and the count is treated as 1 when activation is performed consecutively from the first departure warning to the second departure warning, or when activation is performed consecutively from the second departure warning to the first departure warning.

A ninth aspect of the present invention is a computer-readable non-transitory storage medium storing a program that causes a computer to: recognize a surrounding situation of a vehicle; determine whether the vehicle is likely to depart from a traveling lane based on a result of the recognition; and output a departure warning to a driver of the vehicle when it is determined that the vehicle is likely to depart from the traveling lane, in which the departure warning includes a first departure warning when the vehicle is traveling on a road other than a curved road and a second departure warning when the vehicle is traveling on a curved road, the number of activations of the first departure warning and the number of activations of the second departure warning are counted, and the content of the departure warning is changed when the number of activations is increased, and the count is treated as 1 when activation is performed consecutively from the first departure warning to the second departure warning, or when activation is performed consecutively from the second departure warning to the first departure warning.

According to the first to ninth aspects, it is possible to prevent occupants from feeling annoyed.

For example, departure warnings may be activated consecutively at the entrance of a curved road. When the intensity of a warning is increased through a plurality of activations within a predetermined time, occupants feel annoyed if the intensity of the warning is increased by counting each function as one activation during consecutive activations. Thus, it is possible to reduce the occupants' annoyance by counting consecutive activations as one activation.

According to the second aspect, when it is difficult to inform the driver that switching has been made to a different function, the count is set to one, thereby making it possible to perform appropriate counting in accordance with the driver's recognition.

According to the third, fourth or sixth aspect, it is possible to effectively give a notification so that the driver performs an appropriate driving operation.

According to the fifth aspect, it is possible to prompt the driver to perform appropriate driving by turning off the function.

### BRIEF DESCRIPTION OF THE DRAWINGS

FIG. 1 is a configuration diagram of a vehicle system using a vehicle control device according to an embodiment.

FIG. 2 is a diagram illustrating control executed by a first departure control unit.

FIG. 3 is a diagram illustrating control executed by a second departure control unit.

FIG. 4 is a diagram illustrating an example of state transitions of first and second departure warnings in the embodiment.

FIG. 5 is a diagram illustrating an example in which the number of activations is counted as 1.

FIG. 6 is a diagram (1) illustrating a specific example of a departure warning.

FIG. 7 is a diagram (2) illustrating a specific example of a departure warning.

FIG. 8 is a diagram illustrating a departure warning in a first scene.

FIG. 9 is a diagram illustrating a departure warning in a second scene.

FIG. 10 is a diagram illustrating a departure warning in a third scene.

FIG. 11 is a diagram illustrating a departure warning in a fourth scene.

FIG. 12 is a flowchart showing an example of a flow of processing executed by the departure control unit.

### DESCRIPTION OF EMBODIMENTS

### First Embodiment

### Overall Configuration

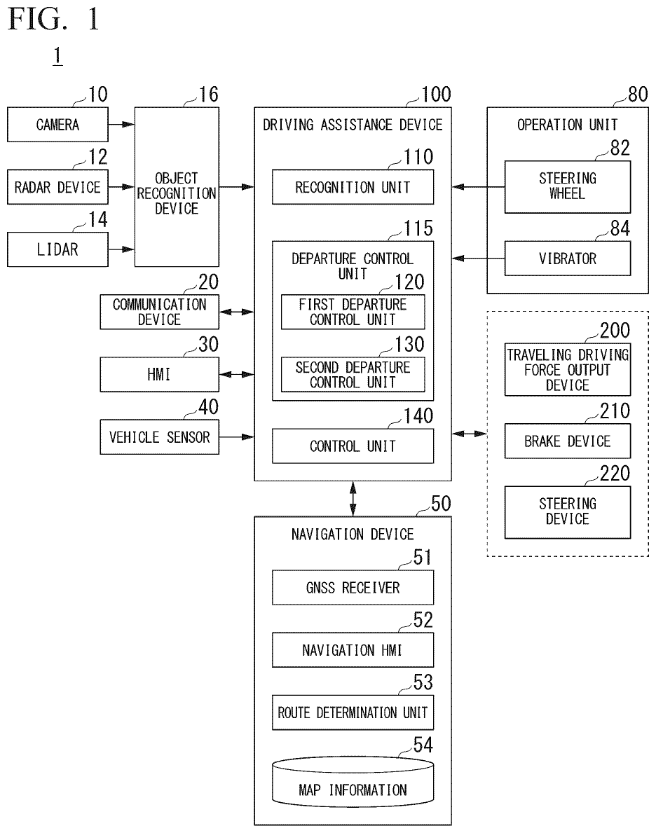

FIG. 1 is a configuration view of a vehicle system 1 using a vehicle control device according to an embodiment. A vehicle in which the vehicle system 1 is mounted is, for example, a two-wheeled, three-wheeled or four-wheeled vehicle, and a driving source thereof is an internal combustion engine such as a diesel engine or a gasoline engine, an electric motor, or a combination thereof. The electric motor is operated using electric power generated by a generator connected to the internal combustion engine, or using discharged electric power from a secondary battery or a fuel cell.

For example, the vehicle system 1 includes a camera 10, a radar device 12, a light detection and ranging (LIDAR) sensor 14, an object recognition device 16, a communication device 20, a human-machine interface (HMI) 30, a vehicle sensor 40, a navigation device 50, an operation unit 80, a driving assistance device 100, a traveling driving force output device 200, a brake device 210, and a steering device 220. These devices and equipment are connected to each other by multiple communication lines, such as a controller area network (CAN) communication line, serial communication lines, wireless communication networks, or the like. Further, the configuration shown in FIG. 1 is merely an example, and some of the components may be omitted, or other components may be added. The driving assistance device 100 is an example of “a vehicle control device.”

For example, the camera 10 is a digital camera using a solid-state imaging element such as, for example, a charge-coupled device (CCD) or a complementary metal oxide semiconductor (CMOS). The camera 10 is attached to any location on a vehicle in which the vehicle system 1 is mounted (hereinafter, a vehicle M). When capturing an image of the front, the camera 10 is attached to a front windshield upper portion, a rearview mirror back surface, or the like. The camera 10 captures images of the surroundings of the vehicle M repeatedly, for example, periodically. The camera 10 may also be a stereo camera.

The radar device 12 emits radio waves, such as millimeter waves, around the vehicle M and detects the radio waves reflected by objects (reflected waves) to detect at least a position (distance and azimuth) of the object. The radar device 12 is attached to the vehicle M at an arbitrary location. The radar device 12 may detect the position and speed of the object using a frequency modulated continuous wave (FM-CW) method.

The LIDAR 14 emits light (or electromagnetic waves with a wavelength close to the light) to the surroundings of the vehicle M, and measures scattered light. The LIDAR 14 detects the distance to the subject on the basis of the time between light emission and reception. The emitted light is, for example, a pulsed laser beam. The LIDAR 14 is attached to an arbitrary position of the vehicle M.

The object recognition device 16 performs sensor fusion processing on some or all of the detection results from the camera 10, the radar device 12, and the LIDAR 14 to recognize the position, the type, the speed, or the like, of the object. The object recognition device 16 outputs the recognition results to the driving assistance device 100. The object recognition device 16 may output the detection results of the camera 10, the radar device 12, and the LIDAR 14 to the driving assistance device 100 as they are. The object recognition device 16 may be omitted from a vehicle system 1.

The communication device 20 communicates with other vehicles in the vicinity of the vehicle M using, for example, a cellular network, a Wi-Fi network, Bluetooth (Registered trademark), dedicated short range communication (DSRC), etc., or communicates with various server devices via a wireless base station.

The HMI 30 presents various pieces of information to the occupant of the vehicle M and accepts input operations from the occupant. The HMI 30 includes, for example, various display devices, a speaker, a buzzer, a touch panel, a switch, and keys. The HMI 30 includes a display device. The display device (display) is, for example, a display device, i.e., a multi-information display, for displaying various information in the vehicle M such as a speedometer indicating a movement speed of the vehicle M or a tachometer indicating a rotational speed of the internal combustion engine provided in the vehicle M provided in the center of the instrument panel of the vehicle M.

The vehicle sensor 40 includes a vehicle speed sensor configured to detect a speed of the vehicle M, an acceleration sensor configured to detect acceleration, a yaw rate sensor configured to detect an angular speed around a vertical axis, an azimuth sensor configured to detect an orientation of the vehicle M, and the like.

The navigation device 50 includes, for example, a global navigation satellite system (GNSS) receiver 51, a navigation HMI 52, and a route determination unit 53. The navigation device 50 stores map information 54 in a storage device such as a hard disk drive (HDD) or a flash memory. The GNSS receiver 51 specifies a position of the vehicle M on the basis of the signal received from a GNSS satellite. The position of the vehicle M may be specified or supplemented by an inertial navigation system (INS) using the output of the vehicle sensor 40. The navigation HMI 52 includes a display device, a speaker, a touch panel, and keys. The navigation HMI 52 may be partially or completely shared with the HMI 30 described above. For example, the route determination unit 53 decides on a route (hereinafter referred to as a route on a map) from the position of the vehicle M identified by the GNSS receiver 51 (or any input position) to a destination input by the occupant using the navigation HMI 52 with reference to the map information 54. The map information 54 is, for example, information in which a road shape is expressed by a link indicating a road and nodes connected by a link. The map information 54 may include a road curvature, point of interest (POI) information, and the like. For example, the map information 54 includes information indicating a specified speed (e.g., a speed limit or a legal speed) for each link indicating a road. The specified speed is information indicating, for example, the speed limit and the legal speed displayed on a road, a signboard provided on a road, or the like.

The navigation device 50 may perform route guidance using the navigation HMI 52 on the basis of the route on map. The navigation device 50 may be realized by, for example, a function of a terminal device such as a smartphone, a tablet terminal, or the like, held by the occupant. The navigation device 50 may transmit the current position and destination to a navigation server via the communication device 20, and acquire the same route as the route on map from the navigation server.

The operation unit 80 includes, for example, an operation switch of a direction indicator, an accelerator pedal, a brake pedal, a shift lever, and other operators (not shown). A sensor that detects an amount of operation or the presence or absence of operation is attached to the operation element, and the detection result is output to the driving assistance device 100 or some or all of the traveling driving force output device 200, the brake device 210, and the steering device 220. The steering wheel does not have to have a ring shape and may have a shape of a deformed steering, a joystick, a button, or the like. A steering grip sensor is attached to the steering wheel.

In addition to the above, the operation unit 80 includes a steering wheel 82 and a vibrator 84.

The vibrator 84 vibrates the steering wheel 82. For example, the vibrator 84 vibrates based on an instruction from the driving assistance device 100 to notify the driver that the vehicle M is approaching a road marking, that the vehicle M has reached a road marking, or that the vehicle M has deviated from a road marking.

The driving assistance device 100 includes, for example, a recognition unit 110, a departure control unit 115 including a first departure control unit 120 and a second departure control unit 130, and a control unit 140. Some or all of these functional units are implemented, for example, by a hardware processor such as a central processing unit (CPU) executing a program (software). Some or all of such constituent elements may be realized by hardware (a circuit unit; including circuitry) such as a large scale integration (LSI), an application specific integrated circuit (ASIC), a field-programmable gate array (FPGA), a graphics processing unit (GPU), and a system on chip (SOC) or may be realized by software and hardware in cooperation. The program may be stored in a storage device such as an HDD, a flash memory, or the like, (a storage device including a non-transient storage medium) of the driving assistance device 100, or may be stored in a detachable storage medium such as a DVD, a CD-ROM, or the like, in advance, or may be installed in a HDD or a flash memory of the driving assistance device 100 by mounting a storage medium (non-transient storage medium) in a drive device.

The recognition unit 110 recognizes the position of an object in the periphery of the vehicle M and states such as a speed and acceleration thereof on the basis of information input from the camera 10, the radar device 12, and the LIDAR 14 via the object recognition device 16. The position of the object is recognized, for example, as a position on absolute coordinates using a representative point (a center of gravity, a driving shaft center, or the like) of the vehicle M as an origin, and used in control. The position of the object may be expressed by a representative point such as the center of gravity or a corner of the object, or may be expressed by an area.

The “state” of the object may include the acceleration or jerk of the object, or the “action state” (e.g., whether or not the lane is changing or is about to change).

For example, the recognition unit 110 recognizes a road marking near the vehicle M and recognizes a traveling lane on the basis of the recognized road marking. The recognition unit 110 may recognize a traveling lane by recognizing traveling road boundaries (road boundaries), which are not limited to the road marking but include road markings, shoulders, curbs, median strips, guard rails, and the like. This recognition may take into account the position of the vehicle M obtained from the navigation device 50 and the processing results from the INS. The recognition unit 110 recognizes a temporary stop line, an obstacle, red traffic light, a toll gate, other road events, a mark (a speed limit) marked on a road, and a road sign on which the speed limit is marked.

When the traveling lane is recognized, the recognition unit 110 recognizes a position or a posture of the vehicle M with respect to the traveling lane. For example, the recognition unit 110 may recognize a gap of a reference point of the vehicle M from the center of the lane and an angle formed between the movement direction of the vehicle M and a line connected to the center of the lane as a relative position and posture of the vehicle M related to the traveling lane. Instead, the recognition unit 110 may recognize a position of a reference point of the vehicle M with respect to one side line of the traveling lane (a road marking or a road boundary) or the like as the position of the vehicle M with respect to the traveling lane.

### First Departure Control Unit

The first departure control unit 120 prevents the vehicle M from departing from the road while the driver is controlling the vehicle M. The first departure control unit 120 implements a so-called road departure mitigation function (road departure mitigation; RDM). The first departure control unit 120 executes first departure mitigation control when the vehicle M is likely to change lanes or depart from a road marking in a state where a direction indicator is not blinking. Examples of the first departure mitigation control include issuing a warning regarding departure from a road marking recognized by the recognition unit 110, issuing a warning via vibration from the vibrator 84 of the steering wheel 82, and steering assistance to move the vehicle M closer to the center of the lane. Hereinafter, the first departure mitigation control may be referred to as a “first departure warning”.

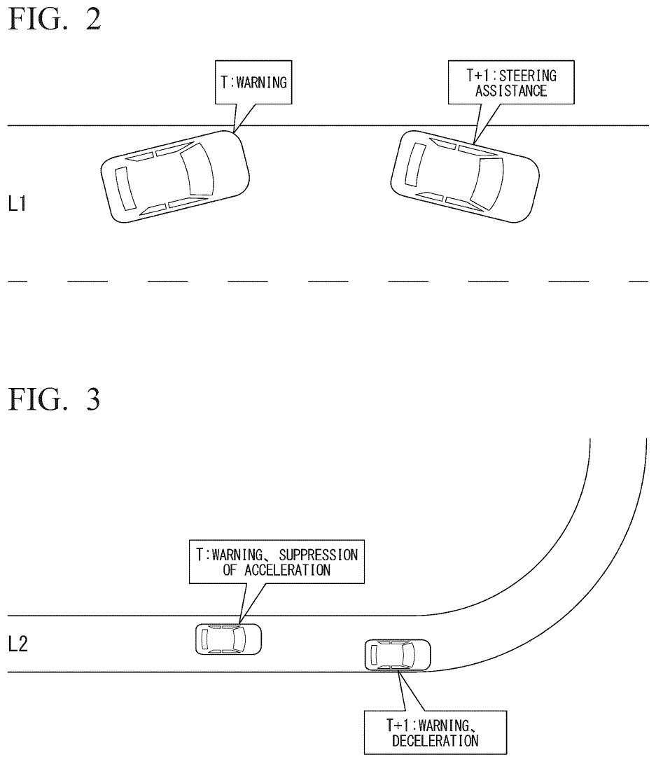

FIG. 2 is a diagram illustrating control executed by the first departure control unit 120. When conditions for first departure control are satisfied at time T, the first departure control unit 120 outputs a warning using the HMI 30. The conditions for the first departure control include the vehicle M reaching a position separated from the center of a lane L1 at a predetermined distance or more or reaching a position separated from the position of a road marking on the lane L1 at a predetermined distance. When the vehicle M is closer to the road marking at time T+1 than the position of the vehicle M at time T, the first departure control unit 120 strengthens the mitigation control more than at time T. Strengthening the mitigation control means, for example, issuing a warning that is more noticeable to a driver, or providing steering assistance to keep the vehicle M in the center of the lane.

By executing the first departure control as described above, the first departure control unit 120 can prevent the vehicle M from departing from the road.

### Second Departure Control Unit

The second departure control unit 130 prevents the vehicle M from departing from a curved road while the driver is controlling the vehicle M. The second departure control unit 130 implements a so-called curved road departure early warning. The second departure control unit 130 executes second departure mitigation control (second departure warning) in a case where the vehicle M is highly likely to depart from the curved road when it approaches the entrance of the curved road. Examples of the second departure mitigation control include issuing a warning regarding departure from a road marking on the curved road, issuing a warning via vibration from the vibrator 84 of the steering wheel 82, suppressing acceleration of the vehicle M, decelerating the vehicle M, and steering assistance to move the vehicle M closer to the center of the lane. The second departure control unit 130 may also execute second departure mitigation control after the vehicle M enters the curved road when the vehicle M is highly likely to depart from the curved road.

The high likelihood is determined by taking some or all of the following target information into consideration. The target information includes, for example, the radius of curvature of the curved road, the degree of change in the curvature of the curved road, an arrival time (for example, TTLC; Time To Line Crossing), and turning acceleration. The arrival time is, for example, an arrival time it takes for vehicle M to reach a road marking, which is obtained based on the position of the road marking with respect to the vehicle M and the state of the vehicle M (for example, a position, a movement direction, a speed, and an acceleration). The turning acceleration is, for example, a predicted turning acceleration of the vehicle M when the vehicle M turns a curved road.

For example, when the radius of curvature of the curved road is equal to or less than a first threshold value, the degree of change in curvature is equal to or greater than a second threshold value, the arrival time is equal to or less than a third threshold value, and the turning acceleration is equal to or greater than a fourth threshold value, it is determined that the vehicle M is highly likely to depart from the curved road, and second departure mitigation control is executed. Hereinafter, the second departure mitigation control may be referred to as a “second departure warning”.

FIG. 3 is a diagram illustrating control executed by the second departure control unit 130. For example, when the vehicle M travels in a lane L2 and reaches a position a predetermined distance before the entrance of a curved road that is subject to second departure mitigation control, and there is a risk that the vehicle M will depart from the curved road, the second departure control unit 130 issues a warning and suppresses acceleration to prompt the driver to recognize the curved road. When the driver does not decelerate the vehicle M and the vehicle M travels and further approaches a road marking of the curved road, the second departure control unit 130 will decelerate the vehicle and perform steering assistance in addition to issuing a warning.

The driving assistance device 100 recognizes curves, for example, based on recognition results of the recognition unit 110. The driving assistance device 100 may recognize curves with reference to high-precision map information stored in a storage unit (not shown) of the driving assistance device 100, or may recognize curves based on the high-precision map information and the recognition results of the recognition unit 110. The high-precision map information is detailed map information that includes information indicating the positions of the curves.

By executing the second departure control as described above, the second departure control unit 130 can prevent the vehicle M from departing from the curved road.

The first departure warning or second departure warning described above may include a warning in the form of an image or a sound, or a warning that lights up or flashes an output unit that outputs predetermined light. Instead of (or in addition to) vibrating the vibrator 84 of the steering wheel 82 described above, control for vibrating the seat in which the driver is seated or a seat belt in use may be included.

Each of the first departure warning and the second departure warning may be issued in warning modes of at least one stage or more with different warning levels, for example. The “different warning levels” means that the types and/or contents of the warnings are different. For example, whether an image is displayed, whether a sound is output, and whether vibration of the vibrator 84 is output are examples of different warning levels. Examples of different warning levels may include different contents or color tones of displayed images, different sound contents or volumes, and different vibration magnitudes and intervals. The “issuing a warning in a warning mode of one stage” means issuing a warning at one type of warning level, and the “issuing a warning in a warning mode of two or more stages” means issuing a warning at two or more types of warning levels in stages, for example, over time or depending on the likelihood of departure or the circumstances of the departure. When issuing a warning in a warning mode of two or more stages, for example, the warning is issued such that the warning level increases in stages. The “increasing the warning level” means increasing the number of types of warnings, highlighting an image by displaying it in a color that is easy for the driver to visually recognize or by flashing the image, increasing the volume of a warning sound, increasing the vibration, or a combination thereof.

In addition to the above-described first departure control and second departure control, the driving assistance device 100 may execute adaptive cruise control (ACC), lane maintenance control for causing the vehicle M to travel in the center of the lane, or control for performing an automatic lane change (ALC) for automatically causing the vehicle M to change lanes when a lane change instruction has been issued by the driver.

The control unit 140 controls various parts of the vehicle M such as the communication device 20 and the HMI 30.

The traveling driving force output device 200 outputs a traveling driving force (torque) to the driving wheels so that the vehicle travels. The traveling driving force output device 200 includes a combination of, for example, an internal combustion engine, an electric motor, and a gearbox, as well as an ECU that controls these. The ECU controls the above-described components in accordance with information input from the driving assistance device 100 or information input from the driving operation element.

The brake device 210 includes, for example, a brake caliper, a cylinder that transmits a hydraulic pressure to the brake caliper, an electric motor that generates the hydraulic pressure in the cylinder, and a brake ECU. The brake ECU controls the electric motor in accordance with the information input from the driving assistance device 100 or the information input from the driving operator so that brake torque according to a brake operation is output to each wheel.

The steering device 220, for example, includes a steering ECU and an electric motor.

The electric motor, for example, applies a force to a rack and pinion mechanism to change the direction of the steered wheels. The steering ECU drives the electric motor in accordance with the information input from the driving assistance device 100 or the information input from the driving operator to change the direction of the steerable wheels.

### Overview

The control unit 140 counts the number of times the first departure warning is activated and the number of times the second departure warning is activated, and changes the content of the departure warning when the number of activations is increased. The count is treated as 1 when activation is performed consecutively from the first departure warning to the second departure warning, or when activation is performed consecutively from the second departure warning to the first departure warning. This processing will be described below.

When the second departure warning is issued consecutively following the first departure warning, the departure control unit 115 does not issue a warning via a sound in the first and second departure warnings, but when the first or second departure warning is issued within a predetermined time after end conditions for the first and second departure warnings are established and the control related to the first and second departure warnings is ended, the departure control unit 115 issues a warning via a sound in the first or second departure warning (a warning sound is output when the second or subsequent activation is performed within 180 seconds after a departure warning is activated).

Transition of Departure Warning

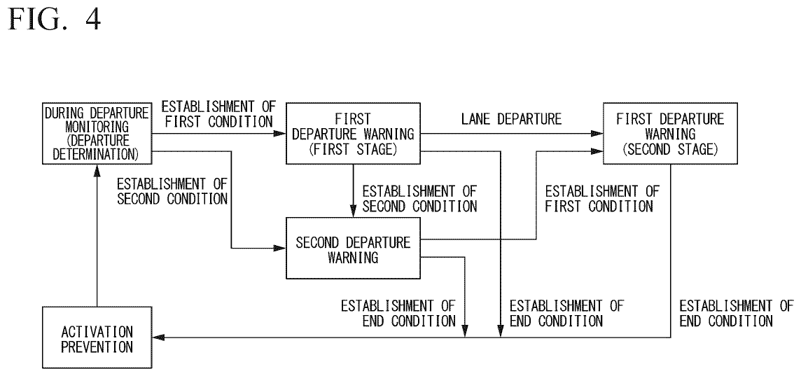

FIG. 4 is a diagram illustrating an example of state transitions of the first departure warning and the second departure warning in the embodiment. In the example of FIG. 4, the departure control unit 115 of the driving assistance device 100 determines whether the vehicle M is subject to the first departure warning at a predetermined period or timing while the vehicle M is traveling, and determines whether the vehicle M is subject to the second departure warning (performs departure monitoring).

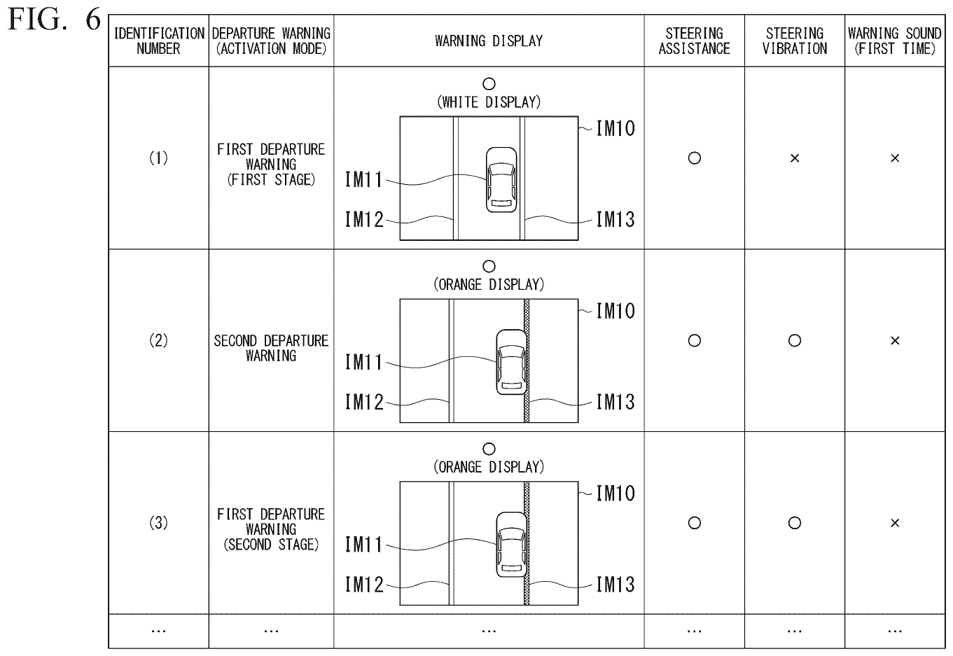

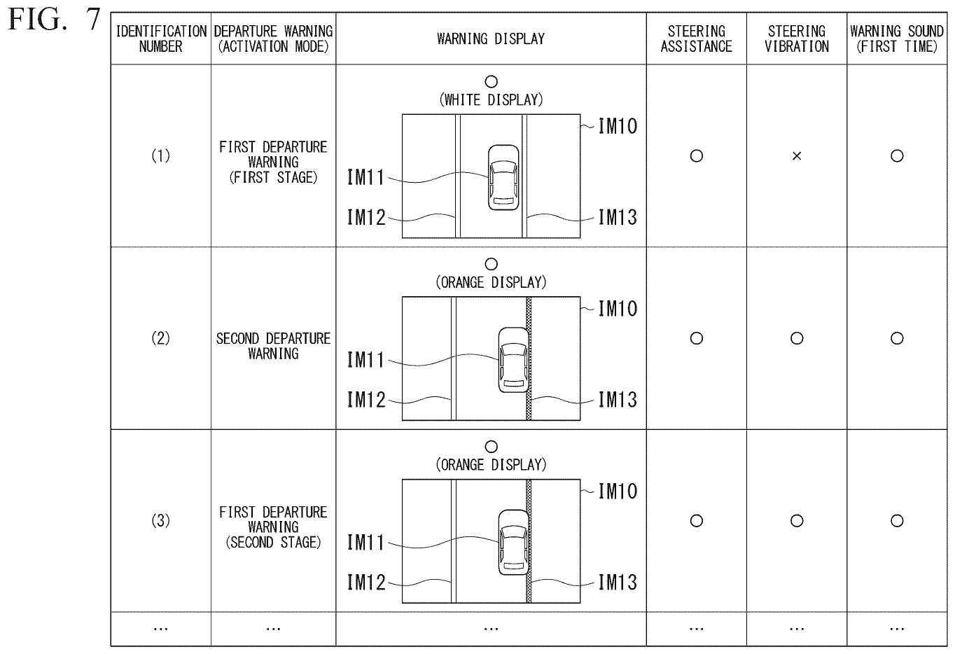

When a first condition is established (when the first condition is satisfied) during the departure monitoring, the departure control unit 115 issues (activates) a first departure warning (first stage). The first condition is, for example, that the shortest distance between a traveling lane marking and the vehicle M is less than a predetermined distance. The first departure warning (first stage) and the second departure warning (second stage) will be described with reference to FIGS. 6 and 7, which will be described later.

Furthermore, when at least a portion of the vehicle M departs from a lane, the departure control unit 115 issues the first departure warning (second stage) whose warning level is higher than the first departure warning (first stage). In the example of FIG. 4, in the first departure warning, in order to achieve both functionality and acceptability, the behavior of the warning is differentiated between before and after lane departure, and the departure is used as a trigger to escalate the warning.

The condition for outputting the first departure warning (second stage) may be that, instead of at least a portion of the vehicle M having departed from the lane, the vehicle M is likely to depart from the lane even after a predetermined time has elapsed since the first departure warning (first stage) was output (or even when the vehicle M has traveled a predetermined distance or more). The likelihood of lane departure means that the vehicle M is traveling to reach a road marking.

When a predetermined end condition is established while the first departure warning (second stage) is being executed (activated), the control unit 140 will suppress (end) the activation of the departure warning, thereby continuing departure monitoring. The predetermined end condition is, for example, that the driver's steering operation (lane maintenance steering operation) has been detected, or that a speed operation (deceleration operation) has been detected, or that it is determined by these operations that the vehicle M is not likely to depart from a traveling lane. The predetermined end condition is, for example, that the vehicle M is in a predetermined state for a period of time equal to or longer than a threshold value. The predetermined state is a state in which a lateral movement speed of the vehicle M is equal to or less than a threshold value, and the vehicle M is located within a predetermined distance from the center of the traveling road (lane). The driver's steering operation is detected based on detection results of a grip sensor (not shown) provided on the steering wheel 82.

When a second condition is established during the departure monitoring, the control unit 140 issues a second departure warning. In this case, the departure control unit 115 issues the second departure warning of a first stage that is lower than the first departure warning. The departure control unit 115 sets the second departure warning to be in a mode at a higher warning level than the mode whose warning level is lowest among different warning modes of a plurality of stages of the first departure warning. Thereby, since a curved road requires more steering than a straight road and thus is more likely to result in departure, the driver can be more efficiently and reliably notified of the level of urgency (risk) of departure on the curved road, allowing the driver to respond promptly.

The second condition is a condition that uses the above-described target information. The second condition may be, for example, that an allowance time TTLC is less than a predetermined time. The departure control unit 115 derives a predicted future route of the vehicle M from the speed and yaw rate of the vehicle M, and calculates an allowance time TTLC (=d/VM) until the vehicle M reaches a lane marking based on a distance (departure route length d) between the derived predicted route and the lane marking (arc) and the speed VM. The departure control unit 115 may determine that the vehicle M is likely to depart from the traveling lane when the allowance time TTLC is less than the predetermined time, and may determine that there is no likelihood of departure when the allowance time TTLC is equal to or greater than the predetermined time.

The target lane marking under the second condition may be limited to an outer lane marking among the inner and outer lane markings that define the curved road. For example, when the curved road curves to the left, the target lane marking is a right-hand lane marking, and when the curved road curves to the right, the target lane marking is a left-hand lane marking. When the target lane marking under the second condition is limited to the outer lane marking as described above, the departure control unit 115 may determine departure under the first condition based on a positional relationship between the inner lane marking and the vehicle M, even when the vehicle M is traveling on the curved road. The departure control unit 115 may also perform determination on a straight road using the same determination condition as for a curved road, and may also perform determination on the curved road using the same determination condition as for the straight road.

When the second condition is established while the first departure warning (first stage) is being issued, the departure control unit 115 switches from the first departure warning to the second departure warning and issues a notification. In this case, the departure control unit 115 issues the second departure warning at a higher warning level (mode) than the first departure warning (first stage) whose warning level is lowest. Thereby, as a result, it is possible to issue departure warnings in stages and to more efficiently and reliably notify the driver of the level of urgency of curve departure.

The departure control unit 115 may switch to the first departure warning when the first condition is satisfied while the second departure warning is being issued. In this case, the departure control unit 115 may maintain the warning level of the second departure warning when the warning level is reduced due to the switching to the first departure warning. For example, when the first condition is established at the same time as when the second condition is no longer met, and the departure warning is consecutively activated, a situation in which danger has not been avoided occurs, and thus it is possible to prevent the driver from misunderstanding the content of the notification due to the warning by preventing the warning level from being reduced. Thus, a more appropriate departure warning can be output depending on a road situation.

In the example of FIG. 4, when the first condition is satisfied while the second departure warning is being issued, the departure control unit 115 issues a first departure warning (second stage) whose warning level is equal to or higher than that of the current departure warning. The warning level of the second departure warning may be equal to the highest warning level of the first departure warning (first departure warning (second stage) in FIG. 4). Thereby, in a situation where danger has not been avoided even when different departure warnings are issued consecutively, the same notification can be issued without switching warnings, thereby reducing the annoyance felt by the driver due to changes in notification. Thus, a more appropriate departure warning can be output depending on a situation.

When a predetermined end condition is established while the first departure warning (first stage) or the second departure warning is being output (for example, when it is determined that the vehicle M is not likely to depart from a lane), the departure control unit 115 will suppress (end) the activation of the departure warning, thereby continuing departure monitoring. Here, the end conditions for the first departure warning (first stage, second stage) and the second departure warning are, for example, the same condition. Thereby, it is possible to prevent the driver from misunderstanding the content of the notification due to any warning remaining, and to reduce the annoyance of the notification.

The end conditions for the first departure warning (first stage, second stage) and the second departure warning may be different from each other. For example, the end condition for the second departure warning may be less likely to be established than the end condition for the first departure warning (first stage, second stage). In this case, a predetermined time of the end condition for the second departure warning described above is set to be longer than a predetermined time of the end condition for the first departure warning.

Counting of Activation of Departure Warning

The requirements for corrective steering (Corrective Steering Function) in the international standards for automatic steering stipulate the following regarding first departure mitigation control (first departure warning) and second departure mitigation control (second departure warning) related to corrective steering.

(1) When corrective steering is activated within 180 seconds without the driver's intervention of steering, a warning sound needs to be output during a second or subsequent activation within 180 seconds.
(2) When the intervention of corrective steering occurs in a third or subsequent activation, a warning sound needs to be output for 10 seconds longer than the previous activation.

When the driver overrides the steering operation in the above case, a target for 180 seconds is canceled. For example, when departure mitigation control including the first departure mitigation control (first departure warning) and the second departure mitigation control (second departure warning) is activated twice, the driving assistance device 100 controls the departure mitigation control function to an off state for 180 seconds, thereby suppressing a third activation. Thereby, a warning sound is prevented from being output for a long period of time due to the second warning sound. Thereby, an excessive warning sound is prevented from being output to the driver.

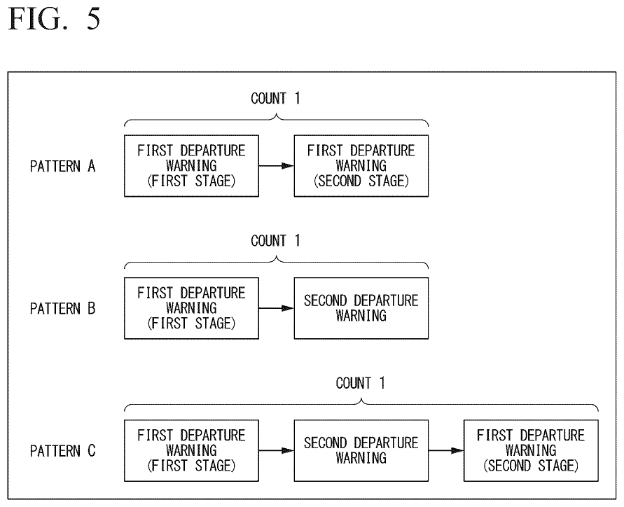

While taking the above description into consideration, it is necessary to perform appropriate departure mitigation control in accordance with the state of vehicle M. In the present embodiment, occupants are prevented from feeling annoyed while issuing an appropriate warning. As illustrated in FIG. 5, when different warnings are issued consecutively before the end condition is established, the departure control unit 115 counts the number of activations as 1, and counts, as “2”, the number of activations of departure mitigation control after the end condition is established. The departure control unit 115 counts the number of activations of the first departure warning and the number of activations of the second departure warning, and after the departure warning is issued after the number of activations has reached two, the departure warning is suppressed for a predetermined time (second predetermined time). For example, the departure control unit 115 counts the number of activations of the first departure warning and the number of activations of the second departure warning, and after the departure warning is issued after the number of activations has reached two, the departure control unit 115 suppresses departure control for a predetermined time (second predetermined time). The second predetermined time is a predetermined time, such as 180 seconds.

Instead of suppressing departure control for a predetermined time (second predetermined time) after a departure warning is issued after the number of activations has reached two as described above, the departure control unit 115 may count the number of activations of the first departure and the number of activations of the second departure warning, and may make the time for the third departure warning longer than the time for the second departure warning. For example, after a departure warning is issued after the number of activations has reached two, the departure control unit 115 may not suppress departure control, but may leave it in an activatable state. When the departure warning is activated, the departure control unit 115 may set a time for outputting the departure warning (warning sound) to be longer than a time for outputting the previous departure warning (warning sound) by a predetermined time (for example, 10 seconds or the like).

FIG. 5 is a diagram illustrating an example in which the number of activations is counted as 1. When departure mitigation control is performed continuously before an end condition is established, as in patterns A, B, and C below, the departure control unit 115 counts the number of activations as “1.” When an activation for increasing the intensity of a departure warning is performed, the departure control unit 115 treats the count as 1. When an activation for decreasing the intensity of a departure warning is performed, the departure control unit 115 does not treat the count as 1 (treats the count as 2). That is, it is the case of escalation that is treated as a continuous activation. Thereby, in the case of a transition to a lower notification intensity by the continuous activation, the driver is informed that switching has been made to a different function, and thus the number of activations is counted as “2.” When the continuous activation does not change the notification intensity or increases the notification intensity, it may be difficult to inform the driver that switching has been made to a different function, and thus the number of activations is counted as “1.” When the notification intensity during the continuous operation is designed not to be decreased, it may be difficult to inform the driver that switching has been made to a different function, and thus the number of activations is counted as “1.”

The pattern A is a pattern in which a first departure warning (second stage) is issued after a first departure warning (first stage) is issued.

The pattern B is a pattern in which a second departure warning is issued after a first departure warning (first stage) is issued.

The pattern C is a pattern in which a first departure warning (first stage) is issued, a second departure warning is issued, and then a first departure warning (second stage) is issued.

When the end condition is established after a transition between the above-described patterns, when the end condition is established after transitioning to the first departure warning (first stage), or when the end condition is established after transitioning to the second departure warning, the departure control unit 115 counts the number of activations as “1”.

Regarding Departure Warning for Which Number of Activations Is “1”

In the above-described departure mitigation control where the number of activations is counted as “1,” the departure mitigation control (departure warning) illustrated in FIG. 6 is performed, for example. FIG. 6 is a diagram (1) illustrating a specific example of a departure warning.

FIG. 6 shows the content of a warning display, whether steering assistance has been performed, whether vibration (steering vibration) has been applied to the steering wheel 82, and whether a warning sound has been issued for each type (first departure warning (first stage), second departure warning, first departure warning (second stage)) of departure warning (activation mode) when the number of activations is counted as “1.”

In FIG. 6, a mark “◯” indicates “applied”, and a mark “X” indicates “being unapplied”. The types and contents of the warnings in the present embodiment are not limited thereto.

In the example of FIG. 6, in the first departure warning (first stage) indicated by identification number (1), a warning is displayed, and a warning display image IM10 is displayed on the display unit of the HMI. In the warning display image IM10, for example, an image IM11 that imitates the vehicle M and images IM12 and IM13 that imitate left and right lane markings defining the traveling lane of the vehicle M are displayed at positions corresponding to the position of the vehicle M. In the warning display for the first departure warning (first stage), a lane marking from which the vehicle M is likely to depart is displayed in the same color (for example, white) or pattern as the other lane markings. In the first departure warning (first stage), steering assistance is executed. In the first departure warning (first stage), steering vibration and a warning sound are not output.

In the second departure warning indicated by identification number (2), as a warning mode in which a warning level is higher than that of the first departure warning (first stage), an image IM13 that imitates a certain lane marking from which the vehicle M is likely to depart is highlighted (for example, displayed in orange) with respect to an image IM12 that imitates the other lane marking in a warning display image IM10 displayed on the display unit. In the second departure warning, steering assistance and steering vibration are executed. In the second departure warning, no warning sound is output.

In the first departure warning (second stage) indicated by identification number (3), as a warning mode in which a warning level becomes higher in stages than that of the first departure warning (first stage), a warning is issued in the same warning mode as the second departure warning. In this manner, it is possible to output a more appropriate departure warning depending on a situation and to enable the driver to promptly be alerted to the surrounding conditions and to perform steering operations and the like.

Regarding Departure Warning for Which Number of Activations Is “2”

The departure control unit 115 counts the number of activations of the first departure warning and the number of activations of the second departure warning within a first predetermined time, and changes the content of the departure warning when the number of activations is increased from 1 to 2. For example, the departure control unit 115 counts the number of activations of the first departure warning and the number of activations of the second departure warning, and adds a warning sound to the departure warning when the number of activations is increased from 1 to 2.

In the above-described departure mitigation control in which the number of activations is counted as “2,” for example, departure mitigation control (departure warning) illustrated in FIG. 7 is performed. FIG. 7 is a diagram (2) illustrating a specific example of a departure warning.

Description will be given focusing on differences from FIG. 6.

In the example of FIG. 6, a warning display, operation assistance, and steering vibration are the same as in FIG. 6 for the first departure warning (first stage) indicated by identification number (1), the second departure warning indicated by identification number (2), and the first departure warning (second stage) indicated by identification number (3). In FIG. 7, a warning sound is output for each departure warning. Since a warning sound is output in the second activation in this manner, the driver can be alerted not to rely excessively on the departure mitigation control.

Departure Warning Based on Behavior of Vehicle M

Next, a departure warning based on the behavior of the vehicle M with respect to a road situation will be specifically described.

In the following description, the road situation is assumed to be in the vicinity of a curved road, and differences in the behavior of the vehicle M will be described by dividing them into several scenes.

### First Scene

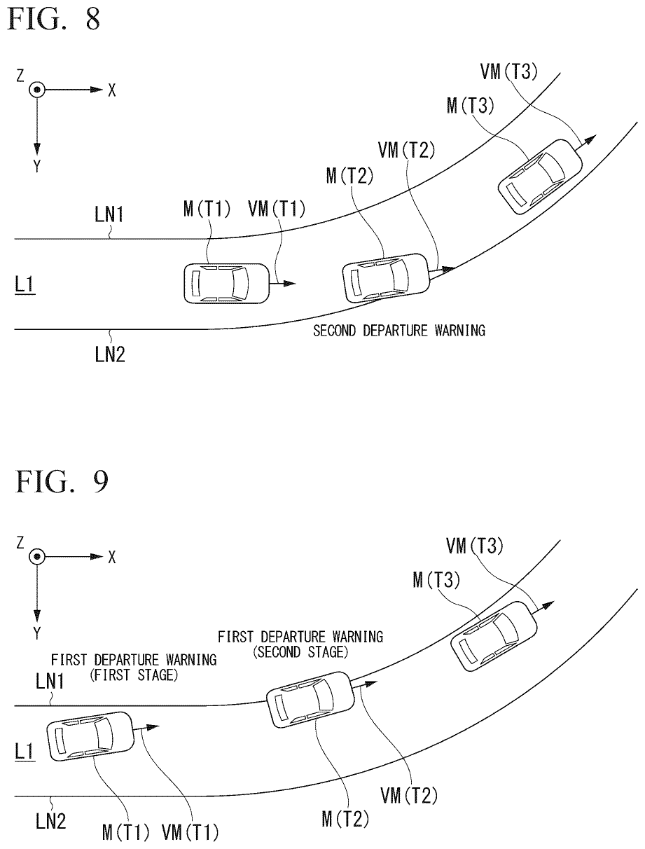

FIG. 8 is a diagram illustrating a departure warning in a first scene. In the example of FIG. 8, it is assumed that the vehicle M is traveling on a lane L1 at a speed VM. The lane L1 is defined by left and right lane markings LN1 and LN2. The example of FIG. 8 shows a curved road that curves to the left with respect to the movement direction of the vehicle M. In this case, the lane marking LN1 is the inside lane marking and the lane marking LN2 is the outside lane marking. In the example of FIG. 8, the position of the vehicle M at time T* is represented as M(T*), and a speed is represented as VM(T*). In the following description, it is assumed that the speed decreases in the order of times T1, T2, and T3. The vehicle M is assumed to be traveling manually by the driver using the operation unit 80, and a departure warning (road departure mitigation control) can be activated depending on a situation.

In the first scene, at time T1, the departure control unit 115 determines that the vehicle M is not likely to depart from the lane L1, and thus no departure warning is output. At time T2, it is assumed that it is determined that the traveling lane L1 of the vehicle M is on a curved road. Furthermore, at time T2, the departure control unit 115 determines that the vehicle M is likely to depart from the lane L1 (lane marking LN2) based on the second condition. In this case, the departure control unit 115 outputs a second departure warning (for example, the warning mode indicated by identification number (2) illustrated in FIG. 6). At time T3, it is determined that the vehicle M is not likely to depart from a lane due to the driver's steering operation or the like, and thus the departure warning is ended.

### Second Scene

FIG. 9 is a diagram illustrating a departure warning in a second scene. In the second scene, the positions of the vehicle M with respect to the lane L1 at times T1 to T3 are different from those in the first scene. Thus, the following description will be given mainly focusing on differences in departure warnings based on differences in the position of the vehicle M. The same applies to third and fourth scenes to be described below.

In the second scene, it is determined that the lane L1 of the vehicle M is not on a curved road at time T1. In this case, the departure control unit 115 determines whether the vehicle M is likely to depart from the lane L1 (lane marking LN1) based on the first condition, and determines that the vehicle M is likely to depart from the lane L1 at time T1. In this case, the departure control unit 115 outputs a first departure warning (first stage) (for example, the warning mode indicated by identification number (1) in FIG. 6). At time T2, at least a portion of the vehicle M departs from the lane L1, and thus a first departure warning (second stage) (for example, the warning mode indicated by identification number (3) in FIG. 6) is output. In the second scene, the lane marking LN1 is the inner lane marking LN1 of the curved road. For this reason, the departure control unit 115 of the embodiment performs departure determination based on the first condition without applying the second condition, even when the lane L1 is on a curved road. At time T3, it is determined that the vehicle M is not likely to depart from a lane due to the driver's steering operation or the like, and thus the departure warning is ended.

### Third Scene

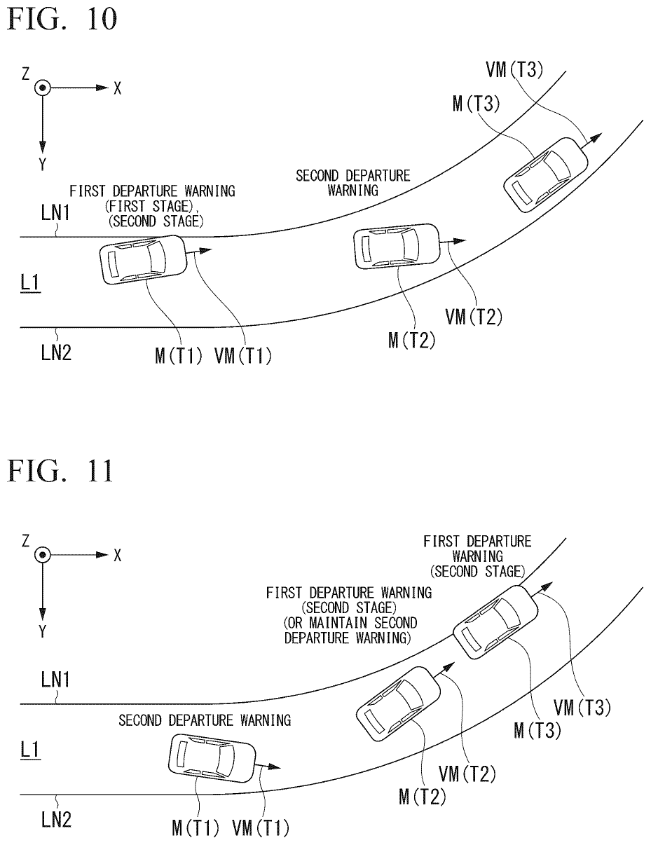

FIG. 10 is a diagram illustrating a depart warning in the third scene. In the third scene, it is determined that the lane L1 of the vehicle M is not on a curved road at time T1. In this case, the departure control unit 115 determines whether the vehicle M is likely to depart from the lane L1 (lane marking LN1) based on the first condition. In the third scene, it is assumed that it is determined that the vehicle M is likely to departure from the lane L1, and immediately thereafter it is determined that at least a portion of the vehicle M has departed from the lane L1. In this case, the departure control unit 115 outputs a first departure warning (first stage), and then (after a predetermined time has elapsed) continuously (stepwise) outputs a first departure warning (second stage (for example, the warning mode indicated by identification number (2) illustrated in FIG. 6)).

At time T2, it is determined that the traveling lane L1 of the vehicle M is on a curved road. The departure control unit 115 determines that the vehicle M is likely to depart from the lane L1 (lane marking LN2) based on the second condition. In this case, the departure control unit 115 outputs a second departure warning (for example, the warning mode indicated by identification number (2) illustrated in FIG. 6). In the third scene, the warning level (warning mode) is set to be the same when switching the departure warning (when switching from the first departure warning (second stage) to the second departure warning), and thus it is possible to reduce annoyance to the driver caused by switching notifications.

At time T3, it is determined that the vehicle M is not likely to depart from a lane due to the driver's steering operation or the like, and thus the departure warning is ended. Here, the end condition for the first departure warning and the end condition for the second departure warning are set to be the same, and thus it is possible to reduce misunderstanding by the driver and annoyance caused by one of the first departure warning and the second departure warning remaining in a situation where the departure warnings are output consecutively, as in the third scene.

### Fourth Scene

FIG. 11 is a diagram illustrating a departure warning in the fourth scene. In the fourth scene, it is assumed that it is determined that the lane L1 of the vehicle M is on a curved road at time T1.

In this case, the departure control unit 115 determines whether the vehicle M is likely to depart from the lane L1 (lane marking LN2) based on the second condition. When it is determined that the vehicle M is likely to depart from the lane L1 at time T1, the departure control unit 115 outputs a second departure warning.

At time T2, it is determined that the vehicle M is not likely to depart from a lane due to the driver's steering operation or the like under the driver's steering control, but immediately thereafter (within a predetermined time after the determination), it is determined that the vehicle M is likely to depart from the lane L1 (lane marking LN1) based on the first condition. In this case, the departure control unit 115 outputs a first departure warning (second stage) (or maintains the warning level of the second departure warning) without making the warning level lower than that of the second departure warning.

A warning is issued in the warning mode indicated by identification number (2) or (3) illustrated in FIG. 6.

At time T3, at least a portion of the vehicle M has departed from the lane L1, and thus the first departure warning (second stage) is maintained. In this manner, in the fourth scene, when switching from the second departure warning to the first departure warning within a predetermined time, control is performed to prevent the warning level from decreasing, and thus it is possible to prevent the driver from misunderstanding a notification and reduce annoyance to the driver caused by switching notifications.

### Flowchart

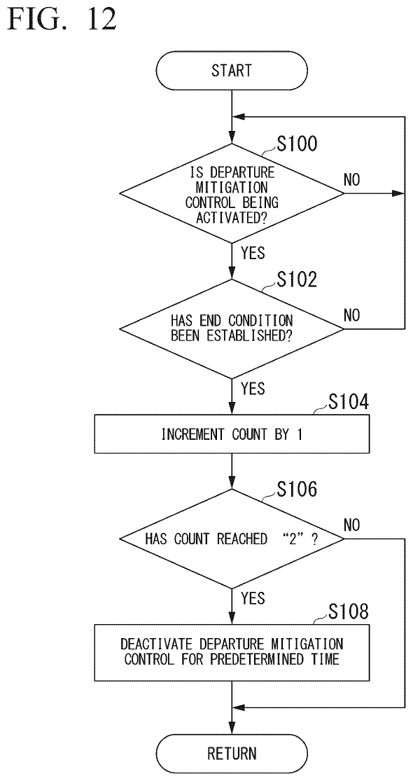

FIG. 12 is a flowchart showing an example of a flow of processing executed by the departure control unit 115. First, the departure control unit 115 determines whether departure mitigation control (first departure warning or second departure warning) is being activated (step S100). When departure mitigation control is being activated, the departure control unit 115 determines whether an end condition has been established (step S102). When a determination result in step S100 is negative, or when a determination result in step S102 is negative, the processing returns to step S100.

When the end condition has been established, the departure control unit 115 increments the count by 1 (step S104). When the end condition is not established in this processing and departure mitigation control is activated consecutively, the consecutive activations are counted as a single activation. Next, the departure control unit 115 determines whether the count has reached “2”(step S106). When the count has not reached “2”, the processing of one routine of this flowchart ends. When the count has reached “2”, the departure control unit 115 deactivates the departure mitigation control for a predetermined time (step S108). A departure warning according to the number of the count is issued as described above in accordance with the above-described processing. Thereby, the processing of one routine of this flowchart ends.

According to the embodiment described above, the driving assistance device 100 counts the number of activations of a first departure warning and the number of activations of a second departure warning. When the number of activations is increased, the driving assistance device 100 changes the content of the departure warning. When activation is performed consecutively from the first departure warning to the second departure warning, or when activation is performed consecutively from the second departure warning to the first departure warning, the count is treated as 1, and thus it is possible to prevent occupants from feeling annoyed.

The embodiment described above can be expressed as follows.

A control device including:
a storage device storing a program; and
a hardware processor, the control device is configured such that
the hardware processor executes the program stored in the storage device to recognize a surrounding situation of a vehicle,
determine whether the vehicle is likely to depart from a traveling lane, based on a recognition result obtained by a recognition unit, and
output a departure warning to a driver of the vehicle when it is determined that the vehicle is likely to depart from the traveling lane,
the departure warning includes a first departure warning when the vehicle is traveling on a road other than a curved road and a second departure warning when the vehicle is traveling on a curved road,
the number of activations of the first departure warning and the number of activations of the second departure warning are counted, and the content of the departure warning is changed when the number of activations is increased, and
the count is treated as 1 when activation is performed consecutively from the first departure warning to the second departure warning, or when activation is performed consecutively from the second departure warning to the first departure warning.

As described above, although a form for performing the present invention has been described using the embodiment, the present invention is not limited to such an embodiment at all, and various modifications and substitutions can be applied within a range not departing from the concept of the present invention.

What is claimed is:

1. A vehicle control device comprising:
a recognition unit configured to recognize a surrounding situation of a vehicle; and
a control unit configured to determine whether the vehicle is likely to depart from a traveling lane based on a recognition result obtained by the recognition unit, and output a departure warning to a driver of the vehicle when it is determined that the vehicle is likely to depart from the traveling lane,
wherein the departure warning includes a first departure warning when the vehicle is traveling on a road other than a curved road and a second departure warning when the vehicle is traveling on a curved road,
the control unit counts a number of activations of the first departure warning and a number of activations of the second departure warning, and changes a content of the departure warning when the number of activations is increased, and
the count is treated as 1 when activation is performed consecutively from the first departure warning to the second departure warning, or when activation is performed consecutively from the second departure warning to the first departure warning.

2. The vehicle control device according to claim 1,
wherein the control unit treats the count as 1 when activation is performed such that the departure warning becomes stronger or when activation is performed such that the departure warning is at an equal level.

3. The vehicle control device according to claim 1,
wherein the control unit counts the number of activations of the first departure warning and the number of activations of the second departure warning within a first predetermined time, and changes the content of the departure warning when the number of activations is increased from 1 to 2.

4. The vehicle control device according to claim 3,
wherein the control unit counts the number of activations of the first departure warning and the number of activations of the second departure warning, and adds a warning sound to the departure warning when the number of activations is increased from 1 to 2.

5. The vehicle control device according to claim 4,
wherein the control unit counts the number of activations of the first departure warning and the number of activations of the second departure warning, and suppresses the departure warning for a second predetermined time after the departure warning is issued after the number of activations has reached two.

6. The vehicle control device according to claim 4,
wherein the control unit counts the number of activations of the first departure warning and the number of activations of the second departure warning, and sets a time of the departure warning for a third time to be longer than a time of the departure warning for a second time.

7. A vehicle control device comprising:
a recognition unit configured to recognize a surrounding situation of a vehicle; and
a control unit configured to determine whether the vehicle is likely to depart from a traveling lane based on a recognition result obtained by the recognition unit, and output a departure warning to a driver of the vehicle when it is determined that the vehicle is likely to depart from the traveling lane,
wherein the departure warning includes a first departure warning when the vehicle is traveling on a road other than a curved road and a second departure warning when the vehicle is traveling on a curved road, and
the control unit does not issue a warning via a sound in the first and second departure warnings when the second departure warning is issued consecutively following the first departure warning, and issues a warning via a sound in the first or second departure warning when the first or second departure warning is issued within a predetermined time after end conditions for the first and second departure warnings are established and a control related to the first and second departure warnings is ended.

8. A vehicle control method comprising causing a computer to:
recognize a surrounding situation of a vehicle;
determine whether the vehicle is likely to depart from a traveling lane based on a result of the recognition; and
output a departure warning to a driver of the vehicle when it is determined that the vehicle is likely to depart from the traveling lane,
wherein the departure warning includes a first departure warning when the vehicle is traveling on a road other than a curved road and a second departure warning when the vehicle is traveling on a curved road,
a number of activations of the first departure warning and a number of activations of the second departure warning are counted, and a content of the departure warning is changed when the number of activations is increased, and
the count is treated as 1 when activation is performed consecutively from the first departure warning to the second departure warning, or when activation is performed consecutively from the second departure warning to the first departure warning.

9. A computer-readable non-transitory storage medium storing a program that causes a computer to:
recognize a surrounding situation of a vehicle;
determine whether the vehicle is likely to depart from a traveling lane based on a result of the recognition; and
output a departure warning to a driver of the vehicle when it is determined that the vehicle is likely to depart from the traveling lane,
wherein the departure warning includes a first departure warning when the vehicle is traveling on a road other than a curved road and a second departure warning when the vehicle is traveling on a curved road,
a number of activations of the first departure warning and a number of activations of the second departure warning are counted, and a content of the departure warning is changed when the number of activations is increased, and
the count is treated as 1 when activation is performed consecutively from the first departure warning to the second departure warning, or when activation is performed consecutively from the second departure warning to the first departure warning.
